(19) United States
(12) Patent Application Publication
(10) Pub. No.: US 2005/0279211 A1
(43) Pub. Date: Dec. 22, 2005

(54) Antimicrobial refrigerator air filter

(76) Inventor: Howard Wayne Swofford, (US)

Correspondence Address: CLIFF D. WESTON;Microban Products Company, Suite 125, 11515 Vanstory Drive, Huntersville, NC, 28078, US

(21) Appl. No.: 11/155,106

(22) Filed: Jun. 17, 2005

Related U.S. Application Data
(60) Provisional application No. 60/580,646, filed on Jun. 17, 2004.

(51) Int. Cl. B01D 46/00

(52) U.S. Cl. 96/226; 55/385.1

(57) ABSTRACT

An air filter suitable for cleaning the air inside of a refrigerated compartment contains an antimicrobial agent exhibiting biocidal properties against microbes entrained in the air of the compartment. The antimicrobial agent can be associated with the media fibers with a binder.

### CROSS-REFERENCE TO RELATED APPLICATION

This application claims priority from U.S. Provisional Patent Application Ser. No. 60/580,646, filed on Jun. 17, 2004.

### BACKGROUND OF THE INVENTION

The present invention relates generally to an air filter, and more specifically to an antimicrobial air filter adapted for use in a refrigerated volume.

Refrigerated compartments, and especially the interior of home food storage refrigerators, are often subject to substantial changes in humidity and can contain a high level of moisture. Although refrigeration can slow the growth and proliferation of unwanted microbes, microbes can quickly spoil food stored in refrigerators and proliferate on the inner surfaces of the compartment and objects therein.

Modern refrigeration systems are designed to utilize air flow throughout the refrigerated compartment to help achieve a uniform temperature distribution within the compartment. Unfortunately, such air flow also serves as a medium by which bacteria can be transported throughout the interior of a refrigerated compartment.

Various devices have been used to filter and clean air inside a space, such as a room, office space, or home. A strong focus of such filtering efforts has been on the removal of allergens from the indoor air of a living space.

In the air within a refrigerated compartment, various particles and organisms can be suspended, such as mold spores, bacteria, viruses, and other small particles unable to be trapped in average filters. If not treated, microorganisms proliferate inside the refrigerated compartment, leading to food spoilage and adverse effects on the taste and aroma of certain foods stored therein.

Prior air filtration efforts have used size filters (including microfilters) for contaminant removal, ultraviolet irradiation to neutralize microorganisms, and carbon or charcoal filters to absorb odors.

Filters, including High Efficiency Particulate Air (HEPA) filters, can be used to cleanse air inside a refrigerated compartment (e.g., a residential refrigerator, a commercial cooler, a vehicular air conditioning unit, a refrigerated transport vehicle) by “straining” contaminants based on size.

U.S. Pat. Nos. 6,454,841 and 6,736,885 discuss an air filtration system specifically designed for refrigerated compartments. The air filtration system consists of a refrigerator and a plenum chamber having an air inlet and an air outlet. The plenum chamber may be inside or outside of the refrigerator and is connected to a fan that draws air through the plenum. The plenum chamber holds an air filter assembly that can include a UV radiation source or a polymeric HEPA filter. The '079 document discusses polymeric filter media having a bactericidal agents molded within the polymer.

### BRIEF DESCRIPTION OF THE DRAWINGS

FIG. 1 is a front view of a first embodiment of a refrigerated compartment having an air filtration system as disclosed herein.

FIG. 2 is a cross-sectional side view of the air filtration system of FIG. 1.

### DETAILED DESCRIPTION

In one broad aspect, the air filtration system for a refrigerated compartment reduces or substantially eliminates microbes, including but not limited to bacteria, mold, and fungus, from the air within the refrigerated compartment. More specifically, the air filtration system reduces or substantially eliminates bacteria, mold, fungus, and other microbial species from the air inside of a refrigerated compartment such as a home refrigerator used for food storage.

For ease of discussion, the air filtration system disclosed herein will be described in the context of a home refrigerator embodiment.

The present air filtration system 10 can bioremediate the air within a refrigerator, reducing the growth and transport of microbes within the refrigerator. This cleaning is accomplished through the use of an antimicrobial air filtration system 10.

The air filtration system 10 according to the present disclosure preferably comprises a filter assembly 20. The filter assembly 20 has an air inlet port 22 and an air outlet port 24. The filter assembly 20 holds a fibrous filter media 30 intermediate the air inlet port 22 and the air outlet port 24. The fibrous filter media 30 is treated with an antimicrobial agent.

Air drawn through the air inlet port 22 contacts the filter media 30 where it comes into intimate contact with the media 30 and associated antimicrobial agents. The antimicrobial agents work through their various biocidal pathways to eliminate microbes entrained in the air. The air then returns to the interior of the refrigerated compartment C via the air outlet port 24.

In a preferred embodiment, the filter is a microfilter. A microfilter has micropores permeable to air and oxygen and provides the ability to filter out fine particles such as bacteria and other microorganisms and airborne pollutants. Microfilters can be constructed of a variety of materials which can be of a woven or non-woven material. An example of a filter material is polyester.

Microfilter foils also can be employed for cross flow filtration needs. High Efficiency Particulate Air (HEPA) filters, with a filtration size rating of approximately 0.3 microns, are also quite effective for the removal of particulates such as mold spores and pollen.

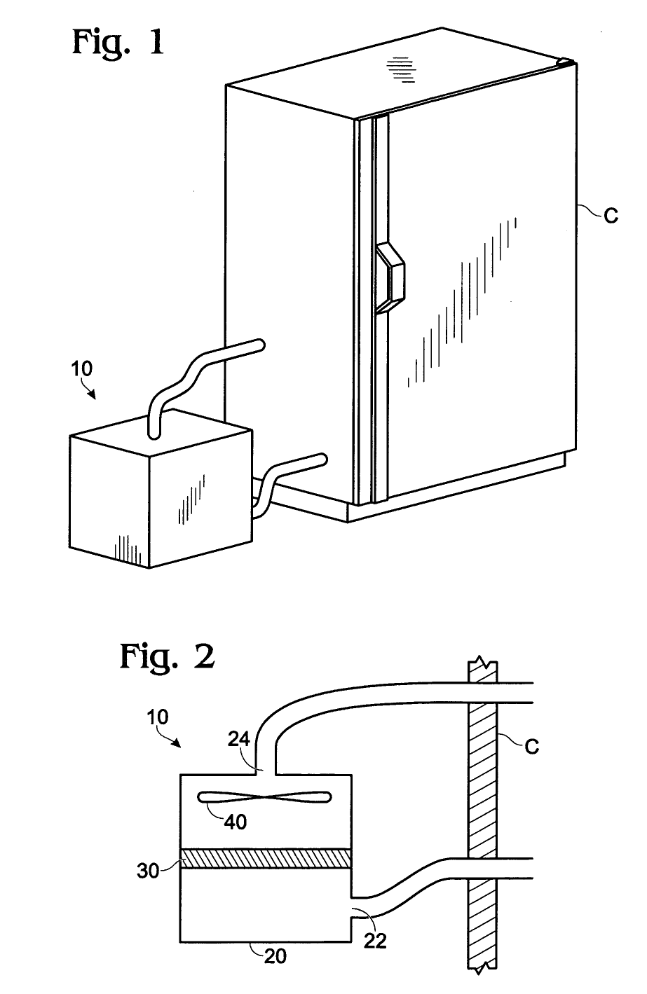

Referring now to FIG. 1, the fibrous filter media 30 preferably is formed of polymeric fiber. The filter media 30 may be woven or non-woven (the latter shown in FIG. 1). Although the choice of polymeric fiber is not critical to the function of the filter media 30, polyester is a preferred polymer.

The polymeric fiber may be of any denier suitable for use as filter media 30. Generally speaking, however, smaller denier fibers are preferred as they provide improved filtering capability. In an exemplary filter embodiment, the fiber used is polyester fiber, is below 10 denier, and more preferably is 6 denier or below.

The embodiment of FIG. 1 comprises two forms of polyester fiber. A first fiber is 6 denier and represents approximately 60% of the filter media 30. A second fiber is 3 denier and represents approximately 40% of the filter media 30.

In one embodiment, the fibrous filter media 30 is imparted with antimicrobial characteristics by topically treating it with an antimicrobial agent. Unlike methods in which antimicrobial agents are added to the polymeric melt and distributed throughout the body of the polymeric article, topical application concentrates the antimicrobial agent on the surface of the individual fibers in the fibrous filter media 30. This increased surface concentration improves efficacy against microbes and reduces the overall quantity of antimicrobial agent needed to achieve a particular result.

Many antimicrobial agents are suitable for use with the air filtration system 10, and antimicrobial agents typically utilized with polymer resins are preferred. Particularly preferred antimicrobial agents include chlorinated phenols (e.g., 2,4,4′-trichloro-2′-hydroxydiphenol), silver and silver-containing compounds, azoles, and zinc and zinc-containing compounds (e.g. zinc pyrithione).

In a first preferred embodiment, the antimicrobial agent is added to a binder used to form the polymeric fiber into a non-woven fibrous filter media 30. Suitable binders include those used to make non-woven materials. Preferred binders include polymeric resins, with polyester and latex acrylic resins being preferred polymeric resins. The antimicrobial agent and the binder should be compatible with each other.

The antimicrobial agent is added to the binder in an amount sufficient to achieve acceptable efficacy when used to form the non-woven fibrous filter media 30. Of course, achieving acceptable efficacy will also be dependent upon how much binder is utilized and the identity of the antimicrobial agent selected. Those skilled in the art are capable of determining the appropriate amounts of binder and antimicrobial agent without undue experimentation.

By way of example, the fibrous filter media 30 shown in FIG. 1 was formed using polyester fiber of 6 and 3 denier (as discussed above). An acrylic binder containing approximately 4000 ppm of zinc pyrithione was used to form the non-woven fibrous filter media 30. The binder was applied such that the resulting filter media 30 was approximately 75% (by weight) fiber and 25% resin binder.

Analytical testing indicated the resulting filter media 30 contained about 1000 ppm zinc pyrithione. Preliminary testing indicated that the resultant filter media 30 was capable of reducing bacterium-sized airborne particles inside a refrigerator by about 45%.

Turning now to FIG. 2, the fibrous filter media 30 of this embodiment remains disposed within the filter assembly 20 with the aid of various support means which may be provided as part of the air filter assembly 20. By way of example, a fitted, or insertable, frame 30 is employed in which the filter media 30 may be inserted to slide in and out as desired. The frame 30 may form an enclosure having an air inlet port 22 and an air outlet port 24.

In one alternative arrangement, the frame 30 may only form only one side of an enclosure by covering an opening the side of the refrigerated compartment C. In this instance, the air outlet port 24 would be the opening in the side of the refrigerated compartment C. In a second alternative arrangement, the filter media 30 may be inserted through a slot or aperture in the housing without perturbation of the air inlet and air outlet 22. In either instance the fibrous filter media 30 is situated gaseously intermediate the air inlet port 22 and the air outlet port 24.

The air inlet port 22 and the air outlet port 24 (FIG. 2) are in fluid connection with the interior of the refrigerated compartment C, enabling the air within the refrigerated compartment C to flow across, flow through, and/or come into intimate contact with the fibrous filter media 30.

The filter assembly 20 may be held in place by one or more brackets or other suitable mechanical means of attachment. Additionally, adhesive on the outside portion of the assembly 20 may be utilized.

A plurality of filters may be serially arranged in decreasing pore size to extend microfilter life. Larger particulates are thereby trapped within the appropriately pore-sized upstream filter, whereas smaller particulates pass through the upstream filter(s) before becoming trapped by a microfilter having a restrictive pore size.

In such a serial filter arrangement, it would not be necessary to associate an antimicrobial agent with large-pore filter media through which microorganisms typically could pass. However, large-pore upstream filters having antimicrobial properties nonetheless can be employed without deviating from the air filtration system 10 disclosed herein.

Means 40 for directing air through the filter assembly 20 is also provided. In one instance, the air directing means 40 is a fan, which may be integrated into the filter assembly 20. Alternatively, the filter assembly 20 can be placed adjacent and in fluid communication with an air directing means already present in the refrigerated compartment C. In still another arrangement, the filter media 30 may be combined with the air directing means 40, for example by shaping a non-woven filter media 30 into or combining the filter media 30 with material shaped into a fan, turbine or other suitable structure used in an air-moving device.

The air filtration system 10 may alternatively be positioned outside of the refrigerated compartment C. What is required is the provision of air contact with, and preferably circulation through, the filter media 30. In most instances, circulation will be accomplished through ducting or tubing, the construction of which is within the skill of one in the art.

One can readily appreciate that air resident within the refrigerated compartment may be recirculated therein (as is preferable to maintain the lowered temperature with reduced energy investment), but also that fresh, external air could be delivered to the interior of the refrigerated compartment. In this latter case, the filter disclosed herein also can be efficaciously employed to reduce or substantially eliminate the introduction of microbes into the interior of the compartment.

The filtration system 10 is suitable for use in any type of commercial or residential refrigeration unit. For example, the refrigerated compartment can also be a retail display case, a commercial transport vehicle, a walk-in cooler/freezer or other industrial installation, and the like.

It is to be understood that while a certain embodiments of the air filtration system have been illustrated and discussed herein, it is not to be limited to the specific forms or arrangements presented in the specification and drawings/figures. It can be appreciated by those skilled in the art that various changes may be made without departing from the essential features disclosed herein and in the following claims.

1. A refrigerated compartment having an air filtration system, comprising:
a plurality of walls defining the refrigerated compartment;
a filter assembly, the filter assembly having an air inlet port and an air outlet port, the air inlet port and air outlet port being in fluid communication with the refrigerated compartment; and
a fibrous filter media situated between the air inlet port and the air outlet port, at least a portion of the fibrous filter media being coated with a binder, the binder comprising an antimicrobial agent.

2. The refrigerated compartment of claim 1 wherein the fibrous filter media comprises a polymer.

3. The refrigerated compartment of claim 2 wherein the polymer comprises polyester.

4. The refrigerated compartment of claim 1 wherein the binder comprises an acrylic binder.

5. The refrigerated compartment of claim 1 wherein the antimicrobial agent comprises an agent selected from the group consisting of chlorinated phenols, azoles, metals, and zinc pyrithione.

6. The refrigerated compartment of claim 5 wherein the antimicrobial agent is zinc pyrithione.

7. The refrigerated compartment of claim 1, further comprising:
means for directing air through the filter assembly.

8. A cooling unit air filtration system, comprising:
a filter housing having an inlet and an outlet, at least one of the inlet and outlet gaseously communicating with a volume to be cooled by the cooling unit;
a fibrous filter media disposed between the inlet and the outlet;
a binder coating disposed on at least a portion of the fibrous filter media; and
an antimicrobial agent in association with the binder.

9. The system of claim 8 wherein at least one of the inlet or the outlet communicates with a volume to be cooled by the cooling unit.

10. The system of claim 8 wherein the fibrous filter media comprises a polymer fiber.

11. The system of claim 10 wherein the polymer fiber has a fineness of 10 denier or less.

12. The system of claim 10 wherein the polymer fiber has a fineness of 6 denier or less.

14*. (canceled)

14. The system of claim 10 wherein the polymer comprises polyester.

15. The system of claim 8 wherein the binder comprises a latex acrylic binder.

16. The system of claim 8 wherein the antimicrobial agent comprises an agent selected from the group consisting of chlorinated phenols, silver and silver-containing compounds, azoles, and zinc and zinc-containing compounds.

17. The system of claim 16 wherein the antimicrobial agent comprises zinc pyrithione.

18. The system of claim 16 wherein the antimicrobial agent comprises 2,4,4′-trichloro-2′-hydroxydiphenol.

19. The system of claim 16 wherein the antimicrobial agent comprises silver.

20. The system of claim 8 further comprising:
an air flow element adapted to flow air into gaseous contact with the fibrous filter media.

21. The system of claim 10 wherein the fibrous filter media comprises a first polymer fiber having a first fineness grade and a second polymer fiber having a second fineness grade.
